(19) United States
(12) Patent Application Publication
(10) Pub. No.: US 2026/0257363 A1
(43) Pub. Date: Sep. 3, 2026

(54) COLLABORATIVE ROBOT HEALTH TEST SYSTEM USING TEST PATH OF TEST CUBE BOX

(71) Applicant: Ajou University Industry-Academic Cooperation Foundation, Suwon-si (KR)

(72) Inventors: Jung Won Lee, Seoul (KR); Minseo Choi, Anseongsi (KR); Jin Se Kim, Suwon-si (KR)

(21) Appl. No.: 19/462,311

(22) Filed: Jan. 28, 2026

(30) Foreign Application Priority Data
Feb. 28, 2025 (KR) 10-2025-0026404

(51) Int. Cl. B25J 9/16

(52) U.S. Cl. CPC B25J 9/1674

(57) ABSTRACT

A collaborative robot health test method of a computing device according to the present disclosure includes identifying a space in which a collaborative robot is installed, and setting the space in which the collaborative robot may operate of the space as a plurality of work spaces, determining an operation range of the collaborative robot for the plurality of work spaces, setting test cube boxes for each of the plurality of work spaces based on an operation points determined through the operation range, determining a test path corresponding to a path along which the collaborative robot is operating based on the test cube boxes, and testing health of the collaborative robot operating along the test path.

### CROSS-REFERENCE TO RELATED APPLICATION

The present application claims priority under 35 U.S.C. § 119(a) to Korean patent application number 10-2025-0026404, filed on Feb. 28, 2025, in the Korean Intellectual Property Office, the entire disclosure of which is incorporated herein by reference.

### TECHNICAL FIELD

The present disclosure relates to a collaborative robot health test system including a collaborative robot and a computing device, and a collaborative robot health test method of a computing device.

### BACKGROUND

A collaborative robot may improve productivity of a factory by collaborating with another device or worker. However, because the collaborative robot works with a human, testing health of the collaborative robot in advance may be important. In addition, because an operating path of the collaborative robot may be different or a type of a work performed by the collaborative robot may be different according to an environment in which the collaborative robot is installed, a collaborative robot health test may require a test tailored to the environment in which the collaborative robot is installed.

### SUMMARY

Embodiments are for collaborative robot health test system and method for testing health of a collaborative robot optimized based on an environment in which the collaborative robot is installed.

According to an embodiment, a collaborative robot health test method of a computing device includes identifying a space in which a collaborative robot is installed, and setting the space in which the collaborative robot may operate of the space as a plurality of work spaces, determining an operation range of the collaborative robot for the plurality of work spaces, setting test cube boxes for each of the plurality of work spaces based on an operation points determined through the operation range, determining a test path corresponding to a path along which the collaborative robot is operating based on the test cube boxes, and testing health of the collaborative robot operating along the test path.

According to an embodiment, a collaborative robot health test system includes a collaborative robot, and a computing device that sets a space in which the collaborative robot is installed as a plurality of work spaces, determines an operation range of the collaborative robot for the plurality of work spaces, sets test cube boxes for each of the plurality of work spaces based on an operation points determined through the operation range, determines a test path corresponding to a path along which the collaborative robot is operating based on the test cube boxes, and tests health of the collaborative robot operating along the test path.

According to embodiments, collaborative robot health test system and method for testing health of a collaborative robot optimized based on an environment in which the collaborative robot is installed are provided.

### BRIEF DESCRIPTION OF THE DRAWINGS

FIG. 1 is a diagram illustrating a collaborative robot health test system according to an embodiment.

FIG. 2 is a diagram illustrating a collaborative robot test unit according to an embodiment.

FIG. 3 is a diagram illustrating a computing device setting a plurality of work spaces based on an environment in which a collaborative robot is installed according to an embodiment.

FIGS. 4 and 5 are diagrams illustrating a computing device determining an operation range of a collaborative robot for a first work space according to an embodiment.

FIG. 6 is a diagram illustrating a computing device setting a first test cube box for a first work space and setting a first test path based on the first test cube box according to an embodiment.

FIG. 7 is a diagram illustrating a computing device determining an operation point of a collaborative robot for a second work space according to an embodiment.

FIG. 8 is a diagram illustrating a computing device setting a second test cube box for a second work space and setting a second test path based on the second test cube box according to an embodiment.

FIG. 9 is a diagram illustrating a computing device setting a first test cube box and a second test cube box according to an embodiment.

FIG. 10 is a diagram illustrating a computing device setting a third test path and a fourth test path based on a first test cube box and a second test cube box according to an embodiment.

FIG. 11 is a diagram illustrating a test path determined based on a first test cube box and a second test cube box according to an embodiment.

FIG. 12 is a flowchart illustrating an operation of a collaborative robot health test system according to an embodiment.

### DETAILED DESCRIPTION

Hereinafter, various embodiments of the present disclosure will be described in detail with reference to the accompanying drawings so that those skilled in the art can easily practice the present disclosure. The present disclosure may be implemented in various different forms and is not limited to the embodiments described herein.

In order to clearly describe the present disclosure, parts irrelevant to the description are omitted, and the same reference numerals designate identical or similar components throughout the specification.

In addition, a size and a thickness of each component shown in the drawings are arbitrarily indicated for convenience of description, and thus the present disclosure is not necessarily limited to the illustrated embodiments. In the drawings, a thickness is enlarged to clearly express various layers and regions. In addition, in the drawings, thicknesses of some layers and regions are exaggerated for convenience of description.

In addition, throughout the specification, when a portion is referred to as “including” a component, this does not exclude another component, but rather implies inclusion of another component, unless otherwise specifically stated.

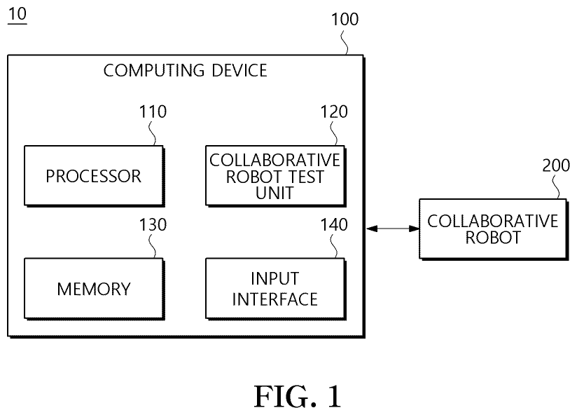

FIG. 1 is a diagram illustrating a collaborative robot health test system according to an embodiment.

Referring to FIG. 1, the collaborative robot health test system 10 may include a computing device 100 and a collaborative robot 200.

In an embodiment, the computing device 100 may control an operation of the collaborative robot 200. In an embodiment, the computing device 100 may include a processor 110, a collaborative robot test unit 120, a memory 130, and an input interface 140.

In an embodiment, the processor 110 may control an overall operation of the computing device 100.

In an embodiment, the collaborative robot test unit 120 may test health of the collaborative robot 200. In an embodiment, the collaborative robot test unit 120 may monitor whether performance of the collaborative robot 200 operating along a test path is deteriorated. In an embodiment, the collaborative robot test unit 120 may be implemented as software, hardware, or a combination of software and hardware. In an embodiment, when the collaborative robot test unit 120 is implemented as software, the collaborative robot test unit 120 may be stored in the memory 130 and executed by the processor 110.

In an embodiment, the memory 130 may store data generated by the computing device 100. In an embodiment, the memory 130 may store data related to the health of the collaborative robot.

In an embodiment, the input interface 140 may receive an input from a user of the computing device 100. In an embodiment, the input interface 140 may be a keyboard, a mouse, or the like.

In an embodiment, the collaborative robot 200 may be one of robots used in an industrial field and may be a robot that performs a work in cooperation with a human in the same space.

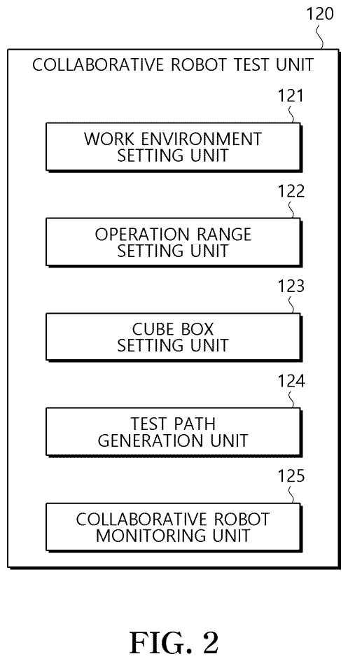

FIG. 2 is a diagram illustrating a collaborative robot test unit according to an embodiment.

Referring to FIG. 2, the collaborative robot test unit 120 may include a work environment setting unit 121, an operation range setting unit 122, a cube box setting unit 123, a test path generation unit 124, and a collaborative robot monitoring unit 125.

In an embodiment, the work environment setting unit 121 may identify a space in which the collaborative robot 200 is installed. In an embodiment, the work environment setting unit 121 may set a space in which the collaborative robot 200 may operate as a plurality of work spaces of the space in which the collaborative robot 200 is installed.

In an embodiment, the operation range setting unit 122 may determine an operation range of the collaborative robot for the plurality of work spaces. In an embodiment, the operation range setting unit 122 may determine maximum and minimum points that the collaborative robot may reach with respect to each of the plurality of work spaces as operation points.

In an embodiment, the cube box setting unit 123 may set test cube boxes based on the operation points determined through the operation range of the collaborative robot 200. In an embodiment, the cube box setting unit 123 may determine the operation points as vertices of the test cube boxes and set the test cube boxes as a result of connecting the vertices.

In an embodiment, the test path generation unit 124 may generate a test path corresponding to a path along which the collaborative robot 200 is to operate based on the test cube boxes. In an embodiment, the test path generation unit 124 may determine a diagonal plane connecting some vertices of the test cube boxes and generate the test path corresponding to a side of the diagonal plane. In an embodiment, the test path generation unit 124 may generate a path along which some vertices of the test cube boxes pass according to an Eulerian circuit as the test path.

In an embodiment, the collaborative robot monitoring unit 125 may control the collaborative robot to operate according to the test path. In an embodiment, the collaborative robot monitoring unit 125 may test the health of the collaborative robot while the collaborative robot operates according to the test path. In an embodiment, the collaborative robot monitoring unit 125 may monitor whether the performance of the collaborative robot operating according to the test path is deteriorated.

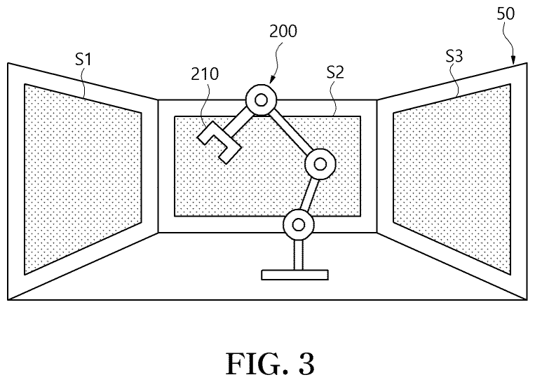

FIG. 3 is a diagram illustrating a computing device setting a plurality of work spaces based on an environment in which a collaborative robot is installed according to an embodiment.

Referring to FIG. 3, the work environment setting unit 121 may identify a space in which the collaborative robot 200 is installed. In an embodiment, the work environment setting unit 121 may set the space in which the collaborative robot 200 is installed as a plurality of work spaces. In an embodiment, the plurality of work spaces may be a space in which the collaborative robot 200 may operate. In an embodiment, the plurality of work spaces may include a first work space S1, a second work space S2, and a third work space S3. In an embodiment, the first work space S1 may be a space facing a front of the robot arm 210 of the collaborative robot 200. In an embodiment, the second work space S2 may be a space facing a right side of the collaborative robot 200. In an embodiment, the third work space S3 may be a space facing a rear side of the collaborative robot 200.

In an embodiment, the work environment setting unit 121 may set the space in which the collaborative robot 200 may operate as a plurality of work spaces of the space in which the collaborative robot 200 is installed. In an embodiment, when a human, equipment, or the like is disposed in the third work space S3, the third work space S3 may be a space in which the collaborative robot may not operate. In an embodiment, the work environment setting unit 121 may identify the third work space S3 in which the human, equipment, or the like is disposed, and may identify the space in which the collaborative robot 200 may operate as the first work space S1 and the second work space S2. In another embodiment, when the second work space S2 and the third work space S3 are spaces in which the collaborative robot 200 may not operate, the work environment setting unit 121 may identify the space in which the collaborative robot 200 may operate as the first work space S1.

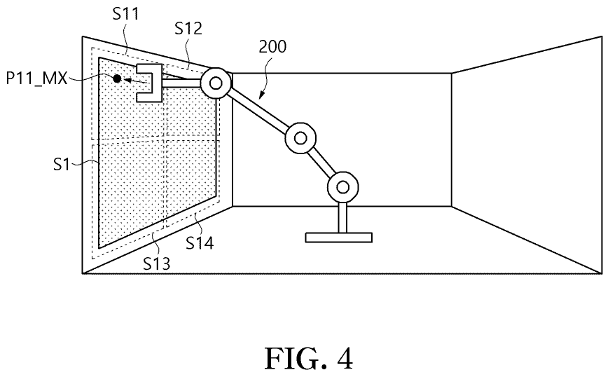

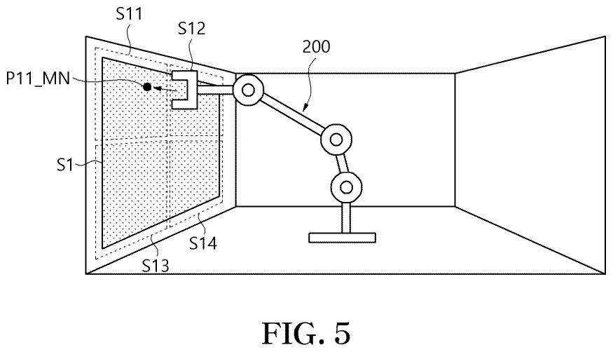

FIGS. 4 and 5 are diagrams illustrating a computing device determining an operation range of a collaborative robot for a first work space according to an embodiment.

In FIGS. 4 and 5, a case in which the work environment setting unit 121 sets the first work space S1 as the space in which the collaborative robot 200 may operate is described as an example.

Referring to FIGS. 4 and 5, the operation range setting unit 122 may determine the operation range of the collaborative robot 200 for the first work space S1. In an embodiment, the operation range setting unit 122 may determine maximum and minimum points that the collaborative robot 200 may reach with respect to the first work space S1 as operation points.

In an embodiment, the operation range setting unit 122 may determine each of maximum and minimum points that the collaborative robot 200 may reach a left upper end space of the first work space S1, maximum and minimum points that the collaborative robot 200 may reach a right upper end space of the first work space S1, maximum and minimum points that the collaborative robot 200 may reach a left lower end space of the first work space S1, and maximum and minimum points that the collaborative robot 200 may reach a right lower end space of the first work space S1 as the operation points.

In an embodiment, the left upper end space of the first work space S1 may correspond to a (1_1)-th sub-space S11. In an embodiment, the right upper end space of the first work space S1 may correspond to a (1_2)-th sub-space S12. In an embodiment, the left lower end space of the first work space S1 may correspond to a (1_3)-th sub-space S13. In an embodiment, the right lower end space of the first work space S1 may correspond to a (1_4)-th sub-space S14.

In an embodiment, the operation range setting unit 122 may determine the maximum point that the collaborative robot 200 may reach with respect to the (1_1)-th sub-space S11 as a (1_1)-th maximum point P11_MX. In an embodiment, the operation range setting unit 122 may determine the minimum point that the collaborative robot 200 may reach with respect to (1_1)-th sub-space S11 as a (1_1)-th minimum point P11_MN. Identically to this, the operation range setting unit 122 may determine maximum and minimum points that the collaborative robot 200 may reach the (1_2)-th sub-space S12, the (1_3)-th sub-space S13, and the (1_4)-th sub-space S14.

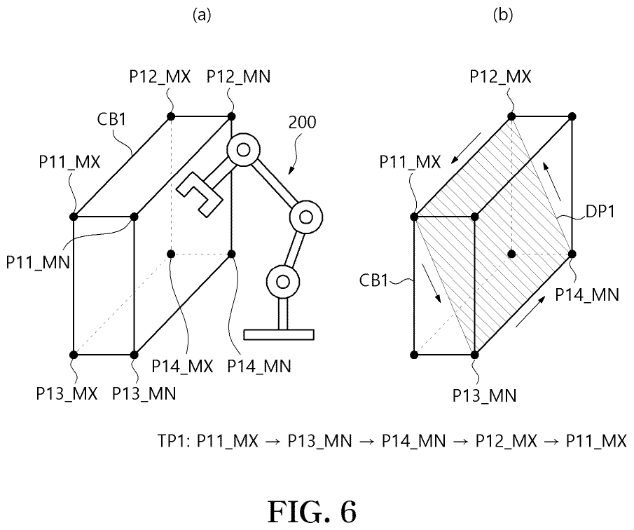

FIG. 6 is a diagram illustrating a computing device setting a first test cube box for a first work space and setting a first test path based on the first test cube box according to an embodiment.

Referring to (a) of FIG. 6, the cube box setting unit 123 may set test cube boxes for each of the plurality of work spaces based on the operation points of the collaborative robot 200 determined through the operation range setting unit 122. In an embodiment, the operation points may include maximum and minimum points that the collaborative robot 200 may reach the plurality of work spaces.

In an embodiment, the cube box setting unit 123 may determine the maximum and minimum points that the collaborative robot 200 may reach the first work space S1 as vertices and set the test cube box connecting the vertices. In an embodiment, the maximum and minimum points of the first work space S1 may include a (1_1)-th maximum point S11_MX, a (1_1)-th minimum point S11_MN, a (1_2)-th maximum point S12_MX, a (1_2)-th minimum point S12_MN, a (1_3)-th maximum point S13_MX, a (1_3)-th minimum point S13_MN, a (1_4)-th maximum point S14_MX, and a (1_4)-th minimum point S14_MN.

In an embodiment, the (1_2)-th maximum point S12_MX and the (1_2)-th minimum point S12_MN may be the maximum and minimum points that the collaborative robot 200 may reach the (1_2)-th sub-space S12. In an embodiment, the (1_3)-th maximum point S13_MX and the (1_3)-th minimum point S13_MN may be the maximum and minimum points that the collaborative robot 200 may reach the (1_3)-th sub-space S13. In an embodiment, the (1_4)-th maximum point S14_MX and the (1_4)-th minimum point S14_MN may be the maximum and minimum points that the collaborative robot may reach the (1_4)-th sub-space S14.

In an embodiment, the cube box setting unit 123 may set a first test cube box CB1 connecting the (1_1)-th maximum point S11_MX, the (1_1)-th minimum point S11_MN, the (1_2)-th maximum point S12_MX, the (1_2)-th minimum point S12_MN, the (1_3)-th maximum point S13_MX, the (1_3)-th minimum point S13_MN, the (1_4)-th maximum point S14_MX, and the (1_4)-th minimum point S14_MN. In an embodiment, the first test cube box CB1 may be a test cube box for the first work space S1.

Referring to (b) of FIG. 6, the test path setting unit 124 may set a test path corresponding to a path along which the collaborative robot 200 performs a test operation based on the first test cube box CB1. In an embodiment, the test path setting unit 124 may determine a diagonal plane connecting some vertices of the first test cube box CB1, and may set the test path along a side of the diagonal plane.

In an embodiment, the test path setting unit 124 may determine a first diagonal plane DP1 connecting the (1_1)-th maximum point S11_MX, the (1_2)-th maximum point S12_MX, the (1_3)-th minimum point S13_MN, and the (1_4)-th minimum point S14_MN of the first test cube box CB1, and may set a path moving along a side of the first diagonal plane DP1 as a first test path TP1. In an embodiment, the first test path TP1 may be a path moving from the (1_1)-th maximum point S11_MX to the (1_3)-th minimum point S13_MN, from the (1_3)-th minimum point S13_MN to the (1_4)-th minimum point S14_MN, from the (1_4)-th minimum point S14_MN to the (1_2)-th maximum point S12_MX, and from the (1_2)-th maximum point S12_MX to the (1_1)-th maximum point S11_MX.

In an embodiment, the collaborative robot monitoring unit 125 may control the collaborative robot 200 to operate along the first test path TP1. In an embodiment, a robot arm 210 of the collaborative robot 200 may move along a main line connecting each of the (1_1)-th maximum point S11_MX and the (1_3)-th minimum point S13_MN, the (1_3)-th minimum point S13_MN and the (1_4)-th maximum point S14_MX, the (1_4)-th maximum point S14_MX and the (1_2)-th maximum point S12_MX, and the (1_2)-th maximum point S12_MX and the (1_1)-th maximum point S11_MX. In an embodiment, the collaborative robot monitoring unit 125 may test the health of the collaborative robot 200 while the collaborative robot 200 operates along the first test path TP1.

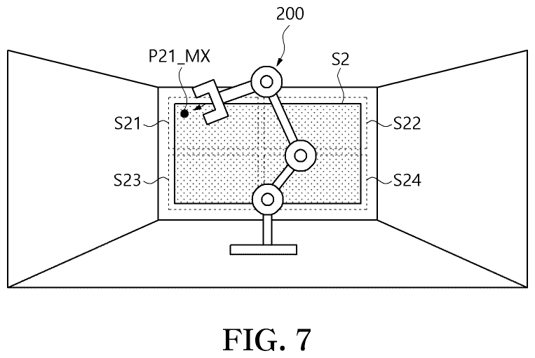

FIG. 7 is a diagram illustrating a computing device determining an operation point of a collaborative robot for a second work space according to an embodiment.

In FIG. 7, a case in which the work environment setting unit 121 sets the second work space S2 as the space in which the collaborative robot 200 may operate is described as an example.

Referring to FIG. 7, the operation range setting unit 122 may determine the operation range of the collaborative robot 200 for the second work space S2. In an embodiment, the operation range setting unit 122 may determine maximum and minimum points that the collaborative robot 200 may reach with respect to the second work space S2 as the operation points.

In an embodiment, the operation range setting unit 122 may determine maximum and minimum points that the collaborative robot may reach a (2_1)-th sub-space S21 corresponding to a left upper end of the second work space S2, maximum and minimum points that the collaborative robot may reach a (2_2)-th sub-space S22 corresponding to a right upper end of the second work space S2, maximum and minimum points that the collaborative robot may reach a (2_3)-th sub-space S23 corresponding to a left lower end of the second work space S2, and maximum and minimum points that the collaborative robot may reach a (2_4)-th sub-space S24 corresponding to a right lower end of the second work space S2 as the operation points.

In an embodiment, the operation range setting unit 122 may determine the maximum point that the collaborative robot 200 may reach with respect to the (2_1)-th sub-space S21 as a (2_1)-th maximum point P21_MX. Identically to this, the operation range setting unit 122 may determine the minimum point that the collaborative robot 200 may reach with respect to the (2_1)-th sub-space S21.

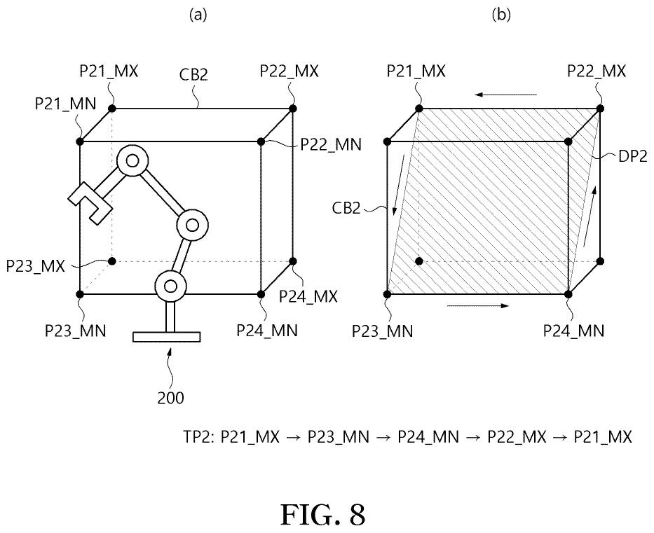

FIG. 8 is a diagram illustrating a computing device setting a second test cube box for a second work space and setting a second test path based on the second test cube box according to an embodiment.

Referring to (a) of FIG. 8, the cube box setting unit 123 may determine maximum and minimum points that the collaborative robot 200 may reach the second work space S2 as vertices, and set a second test cube box CB2 connecting the vertices. In an embodiment, the maximum and minimum points of the second work space S2 may include a (2_1)-th maximum point P21_MX, a (2_1)-th minimum point P21_MN, a (2_2)-th maximum point P22_MX, a (2_2)-th minimum point P22_MN, a (2_3)-th maximum point P23_MX, a (2_3)-th minimum point P23_MN, a (2_4)-th maximum point P24_MX, and a (2_4)-th minimum point P24_MN.

In an embodiment, the (2_1)-th maximum point P21_MX and the (2_1)-th minimum point P21_MN may be maximum and minimum points that the collaborative robot 200 may reach a (2_1)-th sub-space S21. In an embodiment, the (2_2)-th maximum point P22_MX and the (2_2)-th minimum point P22_MN may be maximum and minimum points that the collaborative robot 200 may reach a (2_2)-th sub-space S22. In an embodiment, the (2_3)-th maximum point P23_MX and the (2_3)-th minimum point P23_MN may be maximum and minimum points that the collaborative robot 200 may reach a (2_3)-th sub-space S23. In an embodiment, the (2_4)-th maximum point P24_MX and the (2_4)-th minimum point P24_MN may be maximum and minimum points that the collaborative robot 200 may reach a (2_4)-th sub-space S24. In an embodiment, the second test cube box CB2 may be a test cube box for the second work space S2.

Referring to (b) of FIG. 8, the test path setting unit 124 may set a test path corresponding to a path along which the collaborative robot 200 performs a test operation based on the second test cube box CB2. In an embodiment, the test path setting unit 124 may determine a diagonal plane connecting some vertices of the second test cube box CB2 and set a test path along a side of the diagonal plane.

In an embodiment, the test path setting unit 124 may determine a second diagonal plane DP2 connecting the (2_1)-th maximum point P21_MX, the (2_2)-th maximum point P22_MX, the (2_3)-th minimum point P23_MN, and the (2_4)-th minimum point P24_MN of the second test cube box CB2, and may set a path moving along a side of the second diagonal plane DP2 as a second test path TP2. In an embodiment, the second test path TP2 may be a path moving from the (2_1)-th maximum point P21_MX to the (2_3)-th minimum point P23_MN, from the (2_3)-th minimum point P23_MN to the (2_4)-th minimum point P24_MN, from the (2_4)-th minimum point P24_MN to the (2_2)-th maximum point P22_MX, and from the (2_2)-th maximum point P22_MX to the (2_1)-th maximum point P21_MX.

In an embodiment, the collaborative robot monitoring unit 125 may control the collaborative robot 200 to operate according to the second test path TP2. In an embodiment, the collaborative robot monitoring unit 125 may test the health of the collaborative robot 200 while the robot arm 210 of the collaborative robot 200 moves along a main line connecting each of the (2_1)-th maximum point P21_MX and the (2_3)-th minimum point P23_MN, the (2_3)-th minimum point P23_MN and the (2_4)-th minimum point P24_MN, the (2_4)-th minimum point P24_MN and the (2_2)-th maximum point P22_MX, and the (2_2)-th maximum point P22_MX and the (2_1)-th maximum point P21_MX.

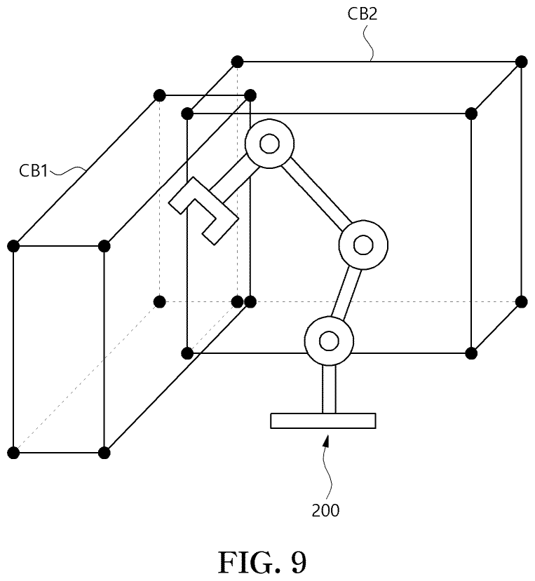

FIG. 9 is a diagram illustrating a computing device setting a first test cube box and a second test cube box according to an embodiment.

In FIG. 9, a case in which the first work space S1 and the second work space S2 are set as spaces in which the collaborative robot 200 may operate is described as an example.

Referring to FIG. 9, the work environment setting unit 121 may identify the space in which the collaborative robot 200 is installed, and set the space in which the collaborative robot 200 may operate among a plurality of work spaces as the first work space S1 and the second work space S2.

In an embodiment, the operation range setting unit 122 may determine minimum and maximum points that the collaborative robot 200 may reach with respect to the first work space S1 as operation points, and may determine minimum and maximum points that the collaborative robot 200 may reach with respect to the second work space S2 as operation points.

In an embodiment, the cube box setting unit 123 may generate test cube boxes based on the operation points determined by the operation range setting unit 122. In an embodiment, the cube box setting unit 123 may set a first test cube box CB1 connecting the operation points of the first work space S1 as vertices, and may set a second test cube box CB2 connecting the operation points of the second work space S2 as vertices.

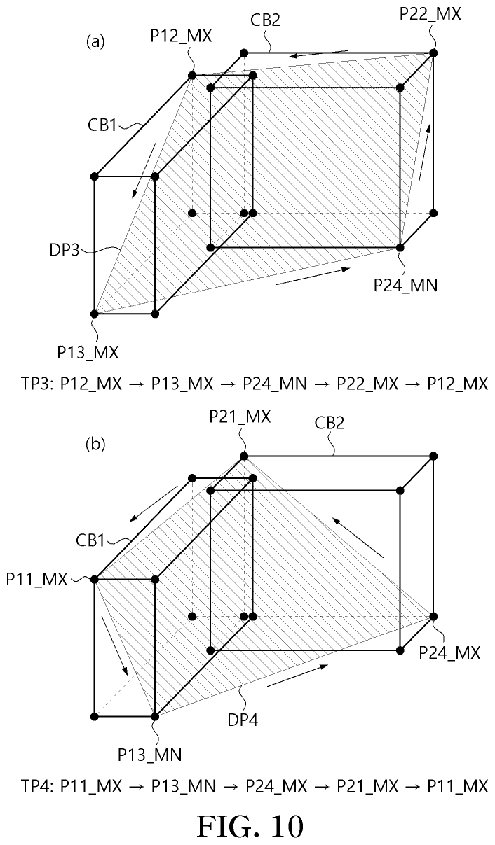

FIG. 10 is a diagram illustrating a computing device setting a third test path and a fourth test path based on a first test cube box and a second test cube box according to an embodiment.

Referring to (a) of FIG. 10, the test path setting unit 124 may set a test path based on the first test cube box CB1 and the second test cube box CB2.

In an embodiment, the test path setting unit 124 may determine a diagonal plane connecting some vertices of the first test cube box CB1 and some vertices of the second test cube box CB2, and set a side of the diagonal plane as the test path.

In an embodiment, the test path setting unit 124 may determine a third diagonal plane DP3 connecting the (1_2)-th maximum point P12_MX and the (1_3)-th maximum point P13_MX among the vertices of the first test cube box CB1, and the (2_2)-th maximum point P22_MX and the (2_4)-th minimum point P24_MN among the vertices of the second test cube box CB2, and may set a path moving along a side of the third diagonal plane DP3 as a third test path TP3.

In an embodiment, the third test path TP3 may be a path along which the robot arm 210 of the collaborative robot 200 to move from the (1_2)-th maximum point P12_MX to the (1_3)-th maximum point P13_MX, from the (1_3)-th maximum point P13_MX to the (2_4)-th minimum point P24_MN, from the (2_4)-th minimum point P24_MN to the (2_2)-th maximum point P22_MX, and from the (2_2)-th maximum point P22_MX to the (1_2)-th maximum point P12_MX.

In an embodiment, the collaborative robot monitoring unit 125 may test the health of the collaborative robot 200 while the robot arm 210 of the collaborative robot 200 moves along the third test path TP3.

Referring to (b) of FIG. 10, the test path setting unit 124 may determine a fourth diagonal plane DP4 connecting the (1_1)-th maximum point P11_MX and the (1_3)-th minimum point P13_MN among the vertices of the first test cube box CB1 and the (2_1)-th maximum point P21_MX and the (2_4)-th maximum point P24_MX among the vertices of the second test cube box CB2, and may set a path moving along a side of the fourth diagonal plane DP4 as a fourth test path TP4.

In an embodiment, the fourth test path TP4 may be a path along which the robot arm 210 of the collaborative robot 200 to move from the (1_1)-th maximum point P11_MX to the (1_3)-th minimum point P13_MN, from the (1_3)-th minimum point P13_MN to the (2_4)-th maximum point P24_MX, from the (2_4)-th maximum point P24_MX to the (2_1)-th maximum point P21_MX, and from the (2_1)-th maximum point P21_MX to the (1_1)-th maximum point P11_MX.

In an embodiment, the collaborative robot monitoring unit 125 may test the health of the collaborative robot 200 while the robot arm 210 of the collaborative robot 200 moves along the fourth test path TP4.

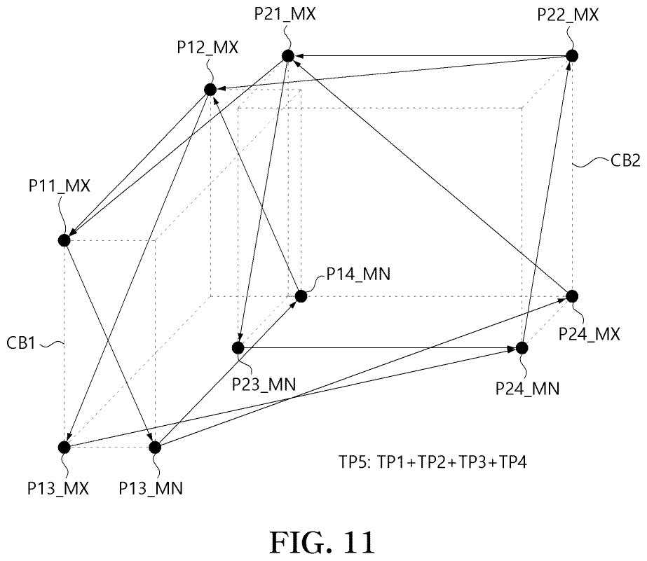

FIG. 11 is a diagram illustrating a test path determined based on a first test cube box and a second test cube box according to an embodiment.

Referring to FIG. 11, the test path setting unit 124 may set a fifth test path TP5 passing through all of the vertices of the first test cube box CB1 and the second test cube box CB2 along which the first test path TP1, the second test path TP2, the third test path TP3, and the fourth test path TP4 pass.

In an embodiment, the test path setting unit 124 may set a path along which the vertices of the first test path TP1, the second test path TP2, the third test path TP3, and the fourth test path TP4 pass according to an Eulerian circuit as the fifth test path TP5. In an embodiment, the fifth test path TP5 according to the Eulerian circuit may be a path set to pass through main lines connecting the vertices of the first test cube box CB1 and the second test cube box CB2 with minimal overlap.

In an embodiment, the fifth test path TP5 may be a path along which the robot arm 210 of the collaborative robot 200 to move from the (1_1)-th maximum point P11_MX to the (1_3)-th minimum point P13_MN, from the (1_3)-th minimum point P13_MN to the (2_4)-th maximum point P24_MX, from the (2_4)-th maximum point P24_MX to the (2_1)-th maximum point P21_MX, from the (2_1)-th maximum point P21_MX to the (1_1)-th maximum point P11_MX, from the (1_1)-th maximum point P11_MX to the (1_3)-th minimum point P13_MN, from the (1_3)-th minimum point P13_MN to the (1_4)-th minimum point P14_MN, from the (1_4)-th minimum point P14_MN to the (1_2)-th maximum point P12_MX, from the (1_2)-th maximum point P12_MX to the (1_3)-th maximum point P13_MX, from the (1_3)-th maximum point P13_MX to the (2_4)-th minimum point P24_MN, from the (2_4)-th minimum point P24_MN to the (2_2)-th maximum point P22_MX, from the (2_2)-th maximum point P22_MX to the (2_1)-th maximum point P21_MX, from the (2_1)-th maximum point P21_MX to the (2_3)-th minimum point P23_MN, from the (2_3)-th minimum point P23_MN to the (2_4)-th minimum point P24_MN, from the (2_4)-th minimum point P24_MN to the (2_2)-th maximum point P22_MX, from the (2_2)-th maximum point P22_MX to the (1_2)-th maximum point P12_MX, and from the (1_2)-th maximum point P12_MX to the (1_1)-th maximum point P11_MX.

In an embodiment, the collaborative robot monitoring unit 125 may control the collaborative robot 200 to operate along the fifth test path TP5. In an embodiment, the collaborative robot monitoring unit 125 may test the health of the collaborative robot 200 operating along the fifth test path TP5.

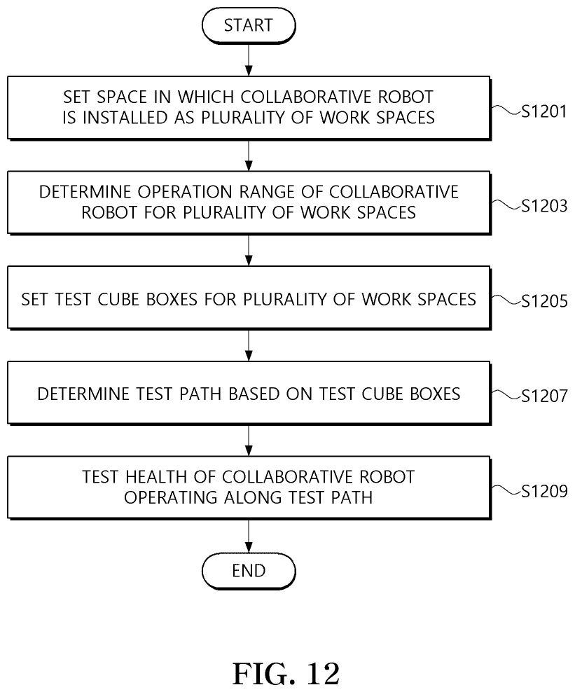

FIG. 12 is a flowchart illustrating an operation of a collaborative robot health test system according to an embodiment.

Referring to FIG. 12, in step S1201, the collaborative robot health test system 10 may set a space in which a collaborative robot is installed as a plurality of work spaces. In an embodiment, the plurality of work spaces may be spaces excluding a space in which the collaborative robot may not operate. In an embodiment, the plurality of work spaces may include a space facing a front of a robot arm of the collaborative robot, a space facing a left side or a right side of the collaborative robot, or a space facing a rear of the collaborative robot.

In step S1203, the collaborative robot health test system 10 may determine an operation range of the collaborative robot for the plurality of work spaces. In an embodiment, the collaborative robot health test system 10 may determine minimum and maximum points that the collaborative robot may reach with respect to the plurality of work spaces as operation points.

In step S1205, the collaborative robot health test system 10 may set test cube boxes for each of the plurality of work spaces. In an embodiment, the collaborative robot health test system 10 may set a first test cube box for a first work space among the plurality of work spaces, and a second test cube box for a second work space among the plurality of work spaces.

In step S1207, the collaborative robot health test system 10 may set a test path based on the test cube boxes. In an embodiment, the collaborative robot health test system 10 may determine a diagonal plane connecting some vertices of one test cube box among the test cube boxes, and set a path moving along a side of the diagonal plane as the test path. In an embodiment, the collaborative robot health test system 10 may determine a diagonal plane connecting some vertices of the first test cube box among the test cube boxes and some vertices of the second test cube box among the test cube boxes, and may set a path moving along a side of the diagonal plane as the test path. In an embodiment, the collaborative robot health test system 10 may set a path along which some vertices of the first test cube box and some vertices of the second test cube box pass according to an Euler circuit as the test path.

In S1209, the collaborative robot health test system 10 may test the health of the collaborative robot 200 operating along the test path.

While the embodiment of the present disclosure is described in detail above, the scope of the present disclosure is not limited thereto, and various modifications and improvements made by those skilled in the art utilizing the basic concept of the present disclosure defined in the following claims also belong to the scope of the present disclosure.

What is claimed is:

1. A collaborative robot health test method of a computing device, comprising:
identifying a space in which a collaborative robot is installed, and setting the space in which the collaborative robot may operate of the space as a plurality of work spaces;
determining an operation range of the collaborative robot for the plurality of work spaces;
setting test cube boxes for each of the plurality of work spaces based on an operation points determined through the operation range;
determining a test path corresponding to a path along which the collaborative robot is operating based on the test cube boxes; and
testing health of the collaborative robot operating along the test path.

2. The collaborative robot health test method of claim 1, wherein the plurality of work spaces include a first work space facing a robot arm of the collaborative robot, and a second work space facing a left side or a right side of the collaborative robot.

3. The collaborative robot health test method of claim 1, wherein determining the operation range comprises determining maximum and minimum points that the collaborative robot reaches with respect to each of the plurality of work spaces as the operation points.

4. The collaborative robot health test method of claim 2, wherein the maximum and minimum points are the maximum and minimum points for a left side and a right side of an upper end or a lower end of each of the plurality of spaces.

5. The collaborative robot health test method of claim 1, wherein setting the test cube boxes comprises determining the operation points as vertices of the test cube boxes and generating the test cube boxes for each of the plurality of work spaces based on the vertices.

6. The collaborative robot health test method of claim 1, wherein setting the test path comprises determining a diagonal plane connecting some vertices of one test cube box among the test cube boxes, and setting the test path along a side of the diagonal plane.

7. The collaborative robot health test method of claim 1, wherein setting the test path comprises determining a diagonal plane connecting some vertices of a first test cube box among the test cube boxes and some vertices of a second test cube box among the test cube boxes, and setting the test path along a side of the diagonal plane.

8. The collaborative robot health test method of claim 1, wherein setting the test path comprises setting a path along which some vertices of a first test cube box among the test cube boxes and some vertices of a second test cube box among the test cube boxes pass according to an Euler circuit as the test path.

9. A collaborative robot health test system comprising:
a collaborative robot; and
a computing device that sets a space in which the collaborative robot is installed as a plurality of work spaces, determines an operation range of the collaborative robot for the plurality of work spaces, sets test cube boxes for each of the plurality of work spaces based on an operation points determined through the operation range, determines a test path corresponding to a path along which the collaborative robot is operating based on the test cube boxes, and tests health of the collaborative robot operating along the test path.

10. The collaborative robot health test system of claim 9, wherein the plurality of work spaces include a first work space facing a robot arm of the collaborative robot, and a second work space facing a left side or a right side of the collaborative robot.

11. The collaborative robot health test system of claim 9, wherein the computing device determines maximum and minimum points that the collaborative robot reaches with respect to each of the plurality of work spaces as the operation points.

12. The collaborative robot health test system of claim 9, wherein the computing device determines maximum and minimum points that the collaborative robot reaches with respect to a first work space among the plurality of work spaces as first operation points.

13. The collaborative robot health test system of claim 12, wherein the computing device sets a box where the first operation points are connected as vertices as a first test cube box among the test cube boxes.

14. The collaborative robot health test system of claim 13, wherein the computing device determines a diagonal plane to which some vertices of the first test cube box are connected and sets the test path along a side of the diagonal plane.

15. The collaborative robot health test system of claim 9, wherein the computing device sets a first test cube box for a first work space among the plurality of work spaces, sets a second test cube box for a second work space among the plurality of work spaces, determines a diagonal plane connecting some vertices of the first test cube box and some vertices of the second test cube box, and sets the test path along a side of the diagonal plane.
